(19) United States
(12) Patent Application Publication
(10) Pub. No.: US 2006/0093351 A1
(43) Pub. Date: May 4, 2006

(54) Aperture device for camera and video camera

(76) Inventor: Ying-Piao Lee, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/976,754

(22) Filed: Nov. 1, 2004

(51) Int. Cl. G03B 9/02

(52) U.S. Cl. 396/505

(57) ABSTRACT

A camera aperture device comprises an aperture body; a light transparent hole being formed at a front end of the aperture body; a front end of the aperture body being formed with a groove; the groove being able to be combined with a lens body so that the lens body is correspondent to the light transparent hole of the aperture body to guide light into the lens body; a driving device combined to the aperture body; an output shaft of the driving device entering into the aperture body to be combined to the aperture blades; thereby the driving device can drive the aperture blades to move automatically in the aperture body so as to close or open the light transparent hole; and a control circuit connected to the driving device for controlling the operation of the driving device.

### FIELD OF THE INVENTION

The present invention relates to cameras and video cameras, and particularly to an aperture device for cameras and video cameras, wherein by using a groove formed on a front end of the aperture body of a camera, the lens body can be directly buckled to the aperture body so that the assembly and detach works can be performed rapidly. Thereby the aperture body of the present invention is an external device which can be used with any lens body of different size without using any hand tool.

### BACKGROUND OF THE INVENTION

Apertures are necessary device for cameras and video cameras for guiding light into the lenses of cameras so as to provide sufficient light to the cameras in capturing images with clear views. Referring to FIGS. 1 and 2, the prior art way for combing the aperture to the lens is illustrated. It is known from the drawing that the prior art aperture A has an opening B at a center thereof. The upper and lower sides of the aperture A are installed with respective round holes D which are communicable to the opening B. An upper and a lower ends of the aperture E are installed with respective screw holes F. The aperture E enters into the lens A through the opening B of the lens A so that the screw hole F is corresponding to the round hole D of the lens A. By the screw C, the aperture E is firmly secured to the lens A for controlling the light source of the aperture A. However although the prior art aperture E can guide light into the lens, when the aperture E is combined to the lens A, the opening B is firstly formed in the lens A for receiving the aperture E. Then the screw C serves to fix the aperture E. The combination is too complex and tedious so that cost is high. Furthermore, once the aperture E is destroyed, detach of the aperture E is performed manually. Therefore, the prior art way for assembly or detaching the aperture E is too complex. Thereby the prior art aperture E is not suitable for any kind of lens A. Thereby one kind of aperture is only suited for one specific kind of lens. This is inconvenient in manufacture.

### SUMMARY OF THE INVENTION

Accordingly, the primary object of the present invention is to provide a camera aperture device, wherein by using a groove formed on the front end of the aperture body of a camera and the lens body is directly buckled to the aperture body so that the assembly and detach works can be performed rapidly. Further, the aperture body of the present invention is an external device which can be used with any lens body of different size without using any hand tool.

To achieve above object, the present invention provides a camera aperture device which comprises an aperture body; a light transparent hole being formed at a front end of the aperture body; a front end of the aperture body being formed with a groove; the groove being able to be combined with a lens body so that the lens body is correspondent to the light transparent hole of the aperture body to guide light into the lens body; a driving device combined to the aperture body; an output shaft of the driving device entering into the aperture body to be combined to the aperture blades; thereby the driving device can drive the aperture blades to move automatically in the aperture body so as to close or open the light transparent hole; and a control circuit connected to the driving device for controlling the operation of the driving device.

The various objects and advantages of the present invention will be more readily understood from the following detailed description when read in conjunction with the appended drawing.

### BRIEF DESCRIPTION OF THE DRAWINGS

FIG. 1 is a prior art view showing that an aperture is combined to a lens.

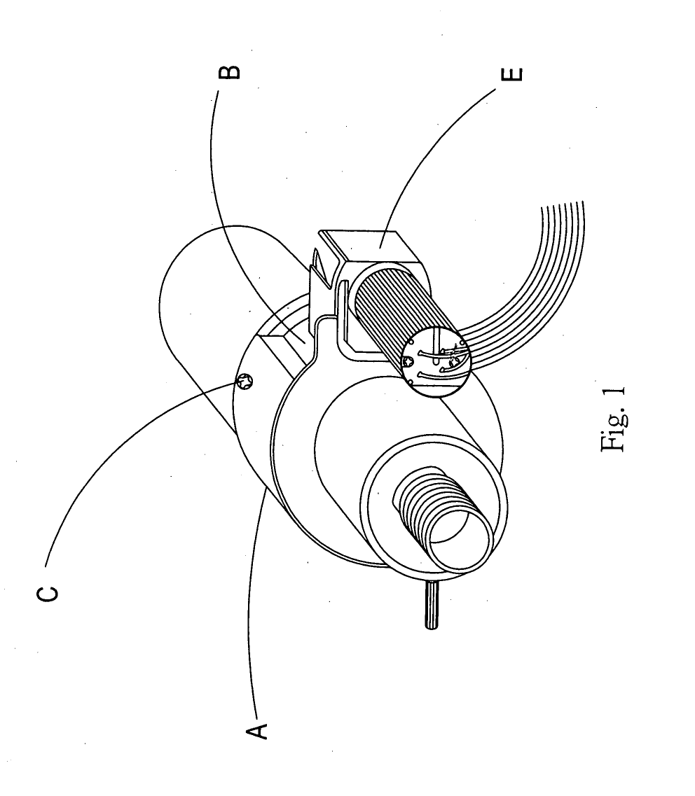

FIG. 2 is a schematic view showing the assembly of the prior art aperture being assembled to a lens.

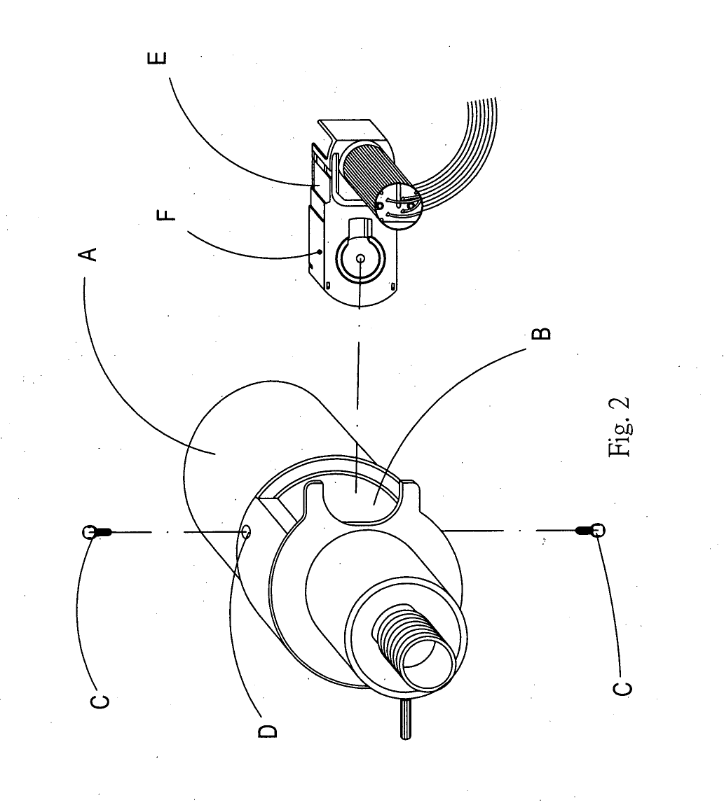

FIG. 3 is a schematic perspective view of the present invention.

FIG. 4 is a schematic view about the aperture structure of the present invention.

FIG. 5 is a schematic view about the aperture structure of the present invention.

FIG. 6 is an assembly view of FIG. 5.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

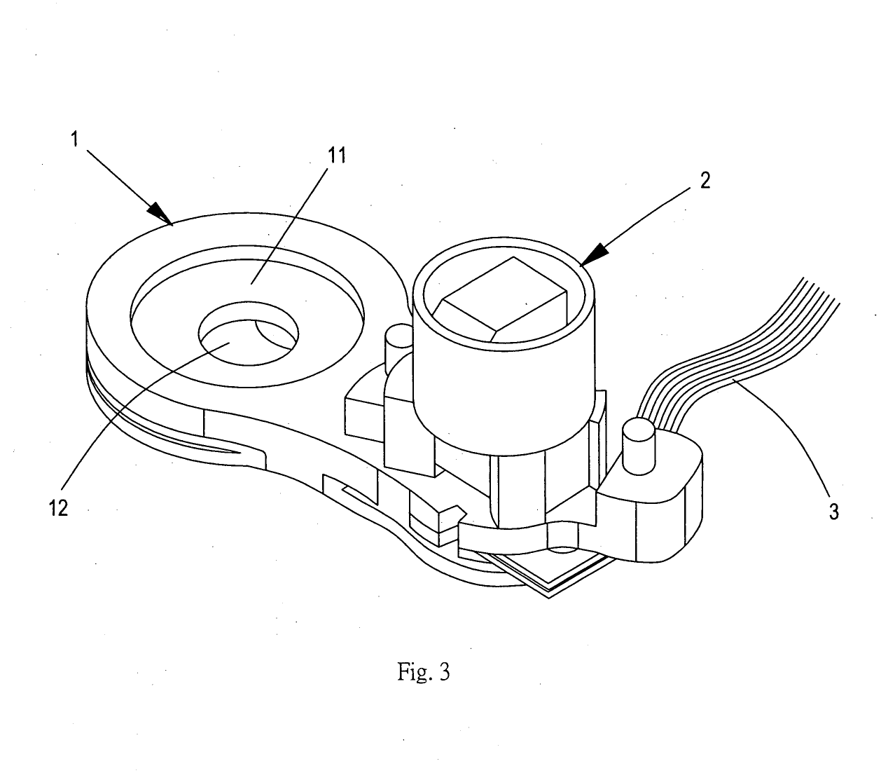

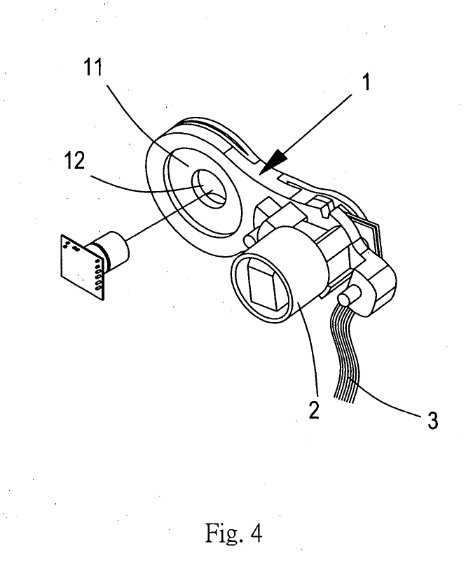

Referring to FIGS. 3 and 4, the camera aperture device of the present invention is illustrated. The camera aperture device has the following elements.

An aperture body 1 is a long cylinder. A front end of the aperture body 1 is formed with a groove 11. A center of the groove 11 is formed with a light transparent hole 12. The aperture body 1 is combined with aperture blades (not shown). The aperture blades are movable in the aperture body 1 so that the light transparent hole 12 is closed or opened.

A driving device 2 is for example, a motor. The driving device 2 is combined to the aperture body 1. An output shaft of the driving device 2 enters into the aperture body 1 to be combined to the aperture blades. Thereby the driving device 2 can drive the aperture blades to move automatically in the aperture body 1 so as to close or open the light transparent hole 12 to control the transparent area of the light transparent hole 12. Thus, the light can be guided into the lens automatically.

A control circuit (not shown) is connected to the driving device 2 through a wire bank 3 for controlling the operation of the driving device 2.

If it is desired to combine the aperture body l to the lens body 4, the groove 11 at the front end of the aperture body 1 is buckled to the lens body 4 so that the lens body 4 is correspondent to the light transparent hole 12 of the aperture body 1. Therefore, the actions of the aperture blades are controllable through the driving device 2 so as to properly guide light to the lens body 4 for capturing images.

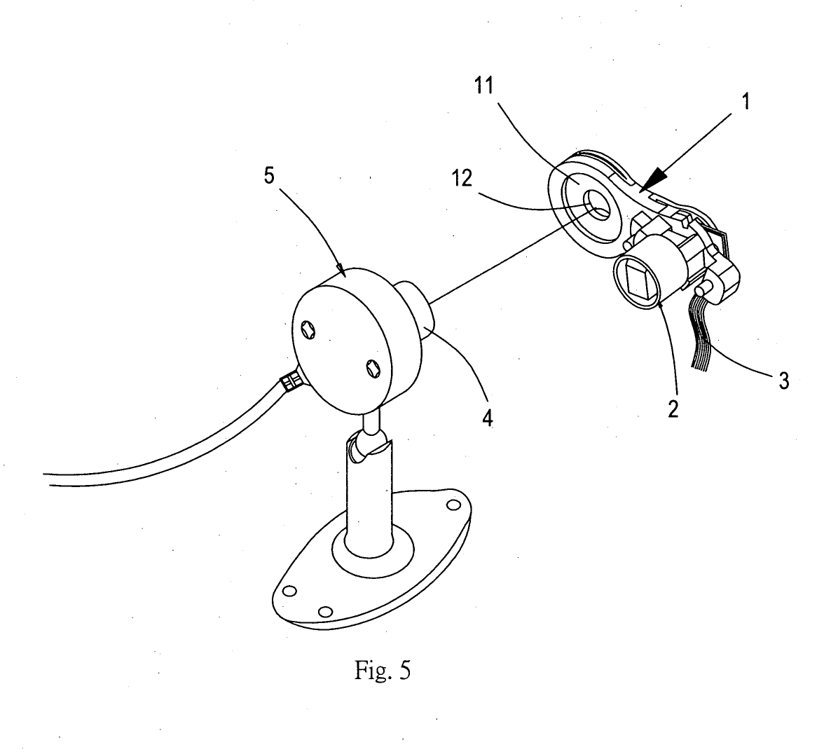

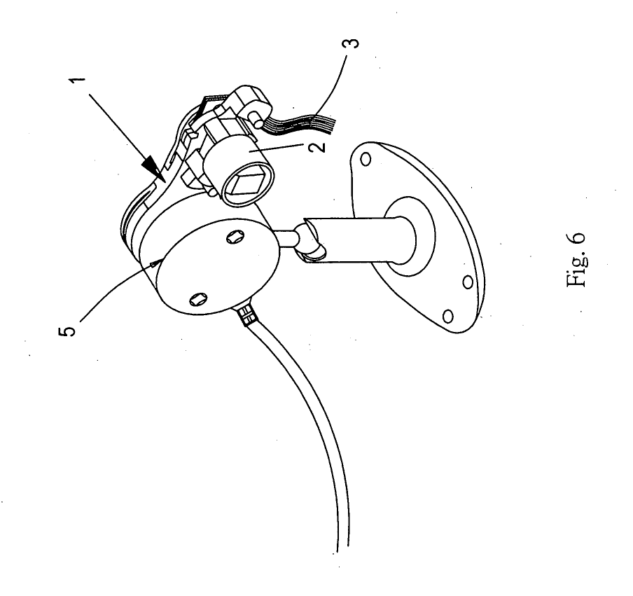

Referring to FIGS. 5 and 6, a schematic view of another embodiment of the present invention is illustrated. In the present invention, the groove 11 of the aperture body 1 is directly buckled to the lens body 4 so that the aperture body 1 is positioned to the lens body 4 rapidly and can be detached from the lens body 4 rapidly without using any hand tool. Thus, the present invention can be used with any lens body 4 of different size, such as digital cameras 5, conventional cameras, etc.

Advantages of the present invention is that the lens body 4 is directly buckled to the aperture body 1 so that the assembly and detach works can be performed rapidly. The aperture body of the present invention is an external device which can be used with any lens body 4 of different size without using any hand tool.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A camera aperture device comprising:
an aperture body; a light transparent hole being formed at a front end of the aperture body; the aperture body being combined with aperture blades; the aperture blades being movable in the aperture body so that the light transparent hole is closed or opened;
a front end of the aperture body being formed with a groove; the groove being able to be combined with a lens body so that the lens body is correspondent to the light transparent hole of the aperture body to guide light into the lens body;
a driving device combined to the aperture body; an output shaft of the driving device entering into the aperture body to be combined to the aperture blades; thereby the driving device can drive the aperture blades to move automatically in the aperture body so as to close or open the light transparent hole; and
a control circuit connected to the driving device for controlling the operation of the driving device.

2. The camera aperture device as claimed in claim 1, wherein the light transparent hole of the aperture body is installed to a center of the groove.

3. The camera aperture device as claimed in claim 1, wherein the driving device is a motor.

4. The camera aperture device as claimed in claim 1, wherein the control circuit is connected to the driving device through a wire bank.
